(19) United States
(12) Patent Application Publication
(10) Pub. No.: US 2019/0262846 A1
(43) Pub. Date: Aug. 29, 2019

(54) DEVICE FOR SPRAYING AN AEROSOL COMPOSITION AT AN INCLINED ACUTE ANGLE

(71) Applicant: Vitaly Ivanovich TITOROV, Moscow (RU)

(72) Inventor: Vitaly Ivanovich TITOROV, Moscow (RU)

(21) Appl. No.: 16/326,318

(22) PCT Filed: Feb. 19, 2016
(86) PCT No.: PCT/RU2016/000090

§ 371 Date: Feb. 18, 2019

(51) Int. Cl. B05B 1/26

(52) U.S. Cl. CPC B05B 1/267

(57) ABSTRACT

Devices deliver the content of an aerosol, and are used in powder-actuated tools. A spray nozzle includes a cylindrical housing having, at a first end, with a base having a mounting bore that extends inside said housing so as to receive a barrel of a powder-actuated tool. The nozzle is equipped with a securing means. The base includes lobes that lie opposite one another in a single plane. A peripheral section of the second end of the housing is located on the same side as one of these lobes and has a curved projection with a rounded outer surface and an upward taper to form a common top surface with an additional cylindrical projection partially embedded into the inner surface of the curved projection. A V-shaped groove in communication with an axial opening of the second end of the housing extends on a free side of the additional projection.

### FIELD OF THE INVENTION

The present invention relates to devices for delivering the content of an aerosol by pressurizing gas from the inside, more particularly, to spray heads used in powder-actuated tools for applying a pressurized aerosol substance by a contact method in the form of jets and/or splashes applied onto different surfaces.

### PRIOR ART

In the prior art, it is known the device for spraying the aerosol composition used in the spray gun (see CA1219177, IPC B05B1/04, published on 17 Mar. 1987 Hi).

The known device for spraying the aerosol composition [1] used in the powder-actuated tool for controlled aerosol spraying of the pressurized medium comprises the cylindrical housing provided with the mounting bore that extends inside the cylindrical housing forming therein the cavity so as to receive the barrel of the powder-actuated tool to be secured to the bottle containing the aerosol composition, the V-shaped recess open on the sides is provided at one of the ends of the housing and is communicated with the through-opening (cavity) for receiving the powder-actuated tool barrel, wherein the width of said recess increases towards the outlet of the spray medium, and the end portion of the through-opening (cavity) facing the opposite to the spray composition side has the variable width which increases towards the same side.

With the known device for composition spraying [1], users can face some difficulties in mating the device with the powder-actuated tool barrel because the device housing lacks any means serving as a rest for user's fingers which would protect fingers from slipping along the housing which can delay the mating process and corresponding installation.

In addition, to enhance the usability, performance and labour efficiency, the known device [1] has no securing means, for instance securable to a bottle or a powder-actuated tool so as to a user could while using the device rapidly and timely replace a damaged device [1] (which can take place after prolonged periods of work, e.g., when heat-insulating rail tank wagons or large accommodation facilities with a corresponding composition, which requires a significant number of standard bottles, more than 100 pcs., to be used).

In this way, the known device is not user-friendly either for preliminary handling or for the application of the spray composition with respect to any surface.

In the prior art, it is known the sprayer for spaying with the aid of the powder-actuated tool the medium which is pressurized in the aerosol bottle (see 034618101, IPC B05B1/04, published on 21 Oct. 1986 [2]).

The known sprayer [2] for pressurized composition spraying which is used in the powder-actuated tool comprises the cylindrical housing provided, at one of the ends, with the mounting bore that extends inside the cylindrical housing and forms the cavity so as to receive therein the powder-actuated tool barrel, the other end of the housing is provided with the shoulder the circumference of which is less than circumference of the cylindrical housing, and the through-opening made therein is communicated at the section of the spray composition outlet with the open on the sides V-shaped through-recess the width of which increases towards the spray medium outlet, and at the opposite section the through-opening is communicated with said cavity formed in the cylindrical housing.

Due to such configuration, the sprayer [2] can coat a surface with a coating having a distinct contour without creating undesirable, strongly noticeable stains.

In addition, for the sake of convenience, the known sprayer [2] comprises a rest for user's fingers which is used while mounting the sprayer on the barrel of the powder-actuated tool. This is ensured by that the circumference of the shoulder provided at one of the sprayer ends is less than the circumference of the cylindrical housing of the sprayer, thus, generating a step therebetween which can be used as a rest to protect user's fingers from slippage while mounting the sprayer [2] on the barrel of the powder-actuated tool, however, the width of such step is not enough to comfortably place user's fingers thereon and provide a reliable rest for fingers, which might have an adverse effect on the duration and comfort of preliminary handling the sprayer [2] and for the replacement operations in a case of the sprayer failure or damage.

Optionally, the known sprayer [2] can be mounted on the barrel of the powder-actuated tool by resting it against any surface, however, in this case, the V-shaped outlet would likely be damaged because it has no protection and would directly contact a surface selected for the rest.

In addition, the known sprayer [2], as well as the known spraying device [1], doesn't comprise any securing means for being secured to the aerosol bottle or the powder-actuated tool the presence of which would facilitate and accelerate user's actions for sprayer [2] replacement in a case of labor- and time-consuming construction works.

The closest prior art of the present invention is the nozzle for surface painting by spraying the pressurized composition (see U.S. Pat. No. 7,128,283, IPC B05B1/00, published on 31 Oct. 2006 [3]).

The known nozzle [3] for surface painting by spraying the pressurized composition comprises the cylindrical housing provided, at the lower end, with the bottom having the mounting bore that extends inside said cylindrical housing and forms therein the cavity to receive the barrel of the powder-actuated tool to be secured to the container with the aerosol composition, at another end of the cylindrical housing the nozzle [3] is provided with the shoulder circumference of which is less than the circumference of the cylindrical housing, and the through-opening made therein at the section of the spray medium outlet from the container is communicated with the V-shaped recess the width of which increases towards the outlet of the spray medium, and at the opposite section the through-opening is communicated with said cavity formed in the cylindrical housing; plate-like protrusions which are opposite to each other adjoin lateral surfaces of the cylindrical shoulder and have the height which is more than the height of the cylindrical shoulder, and the lateral sides of the protrusions are provided with cutouts.

In the known nozzle [3] for surface painting by spraying the pressurized composition, the V-shaped recess the width of which increases towards the spray medium outlet is made with closed sides, thus, significantly narrowing a surface area processed by this nozzle, which, in turn, results in the increased time for certain installation works.

Similarly to the sprayer [2], the known nozzle [3] is also provided with a step, which can be used as a rest for user's fingers for fast and easy mounting the nozzle [3] on the powder-actuated tool prior to the usage. This step is formed by the reduction of a cylindrical housing diameter approximately at the central portion thereof. This step cannot serve as a reliable rest for user's fingers when mounting the nozzle [3] on the barrel of the powder-actuated tool because the step width is not enough for reliable support for user's fingers.

However, the known nozzle [3] can be quickly and reliably mounted on the barrel of the powder-actuated tool by resting the nozzle against any rigid surface, and the risk of damaging the V-shaped recess the width of which increases towards the spray medium outlet is minimized because said V-shaped recess is protected by the plate-like protrusions adjoining lateral surfaces of the shoulder which are opposite to each other and have the height which is more than the height of the cylindrical shoulder.

At the same time, the known nozzle [3] for surface painting by spraying, similarly to the known solutions [1] and [2], is not provided with any device that would temporarily hold the nozzle in close proximity to a user, for instance, onto an aerosol bottle or onto a powder-actuated tool itself, which would allow the user to mate the nozzle [3] prior to its usage or replace it during the usage, for instance, in a case of nozzle damage or failure.

Finally, it should be noted that the known nozzle [3] has quite a sophisticated configuration consisted not of one but several parts, which ultimately would increase the production time and cost.

### DISCLOSURE OF THE INVENTION

The object of the present invention is to provide a spray nozzle of a powder-actuated tool having an outlet of an aerosol composition which allows high-quality and advanced inclined (acute angled) application of a polyurethane composition to a surface being treated without tilting and changing a position of the powder-actuated tool with an aerosol bottle mounted thereon, which can be a reason of the interruption of the smooth and stable discharge of the aerosol composition onto the surface being treated.

Furthermore, the object of the present invention is to provide a simple and reliable spray nozzle which is user-friendly and allows the inclined high-quality treatment of surfaces with an aerosol composition as quickly as possible.

The objective technical effect of the present invention provided by its implementation includes the improved and simplified mating of the spray nozzle and the powder-actuated tool, facilitated and speeded-up replacement of the spray nozzle of the powder-actuated tool in a case of nozzle possible damage or complete failure, in particular, in a case of laborious and time-consuming construction works, the reduced risk of damaging the outlet of the spray nozzle while mating the spray nozzle with the powder-actuated tool using as a rest for this purpose any rigid surface, the increased areas of surfaces being treated, as well as the improved orientation of a polyurethane composition jet in order to achieve the high-effective and high-quality inclined (angular) application onto a surface being treated, the improved high-pressure gas surplus separation and prevented discharge of high-boiling hydrocarbon blowing agents which aid further polymerization and blowing of a product applied onto the treated surface.

Said technical effect addressing said problem is achieved by that the spray nozzle of the powder-actuated tool for controlled aerosol spraying of the polyurethane composition at an inclined acute angle comprises a cylinder-like housing which is provided, at a first end, with a base having a mounting bore that extends inside said cylindrical housing, thus, forming a cavity therein so as to receive a barrel of a powder-actuated tool to be secured to a container containing an aerosol composition, which base is made in the form of lobes that protrude beyond the housing dimensions and lie opposite one another in a single plane and having the dimensions that are sufficient to provide a rest for user's fingers while inserting the barrel of the powder-actuated tool inside the nozzle cavity, a peripheral section of the second end of the housing located on the same side as one of these lobes and having a projection with a curved cross-section an outer surface of which is flushed with an outer surface of the cylinder-like housing and the length of its arc is more than the width of said lobe, wherein the outer surface of the curved projection is rounded and tapers upwards to form a common top surface with an additional cylindrical projection which is concentric to the cylinder-like housing having a diameter less than the diameter of the latter and has a lateral wall partially embedded into an inner surface of said curved projection, wherein on a free side of the additional projection from the top surface to an underlying axial section an inclined, an acute-angled V-shaped groove is made across the width in communication with an axial opening of the second end of the housing and dividing the additional projection into parts, wherein a free part of these parts is smaller and its top surface adjoins a second end of the cylinder-like housing and is located at an oblique angle thereto, wherein the lobes of the base comprise an antislip surface, and the spray nozzle comprises a securing means for securing the nozzle in an out-of-service state.

In accordance with one of the preferred embodiments of the present invention, the securing means is made so that in a plan view the spray nozzle has a form of a clip or close to that form.

In accordance with one of the specific embodiments of the present invention, the securing means has a form of a rod at an end of an extremity of which an arrow-like tip is located opposite to which and perpendicular to the rod is a rest in the form of a crossbar.

In accordance with one of the preferred embodiments of the present invention, a spray nozzle of a powder-actuated tool for controlled aerosol spraying of a polyurethane composition at an inclined acute angle is produced as an integral part and in the form of a cylinder-like housing which is provided, at a first end, with a base having a mounting bore. The base is produced in the form of lobes provided with an antislip surface which protrude beyond the housing dimensions and lie opposite one another in a single plane and have the dimensions that are sufficient to provide a rest for user's fingers while inserting a barrel of the powder-actuated tool inside the nozzle cavity. This particular configuration provides a reliable rest for user's fingers allowing the fingers to fit completely and with comfort to the lobe surfaces, thus, providing a comfortable rest contributing to a fast and easy mating of the spray nozzle and the barrel of the powder-actuated tool prior to the works with or during the use of the nozzle by replacing one spray nozzle with another without interrupting the operation process for a long time, and the antislip surface provides an additional stability for user's fingers, for instance, when the user can suffer some sweating during the laborious application of the aerosol composition onto any surface.

The base of the spray nozzle comprises a mounting bore that extends inside the cylinder-like housing forming therein a cavity for receiving the barrel of the powder-actuated tool. The dimensions of such cavity are selected so that to provide fast and reliable mating therewith and demating therefrom the barrel of the powder-actuated tool that further will be mounted on a container, in particular, on an aerosol bottle containing a polyurethane composition.

The second end of the cylinder-like housing is provided with an additional cylindrical projection which is concentric to the cylinder-like housing having a diameter less than the diameter of the latter and has a lateral wall that is partially embedded into an inner surface of the curved projection. On a free side of this projection from an edge of a common with the curved projection top surface to an underlying axial section an inclined, acute-angled V-shaped groove is made across the width which is in communication with an axial opening of a second end of the cylinder-like housing. The major feature of the present invention is in that the V-shaped groove divides the additional projection into two parts, a free part of these parts is smaller and its top surface adjoins the second end of the cylinder-like housing and is located at an oblique angle thereto. As was mentioned above, the object faced by the inventors was the provision of a spray nozzle outlet for composition discharging (distribution) which would allow high-quality and fast inclined (at an angle) and uniform application of a polyurethane composition, in particular, a single-component foam polyurethane insulant. So, it was surprisingly found that the inventive configuration of the widthwise inclined acute-angled V-shaped groove serving as a composition outlet which divides the additional projection into parts, one of which is smaller and has a top surface adjoining the second end of the cylinder-like housing and extending under an acute or obtuse angle thereto, provides the best inclined (angular) orientation of a directed jet of a pre-polymer to achieve the uniform and fast inclined (angular) application of the spray composition onto a surface, in addition, the spray composition is stable for “ripening”, i.e., there is an improvement of the high-pressure gas surplus separation during the polymer discharge which is required during the extrusion. It is significant that this takes place without discharging high-boiling hydrocarbon blowing agents that aid further polymerization and blowing of a product applied onto the surface. Therefore, the surface being treated is coated with a polyurethane medium in a faster, more uniform and qualitative inclined (angular) way.

In accordance with the present invention, the peripheral section of the second end of the cylinder-like housing is located on the same side as one of the lobes and has a projection with a curved cross-section the outer curved surface of which is flushed with the outer surface of the cylinder-like housing and the length of its arc is more than the width of said lobe, wherein the outer surface of the curved projection is rounded and tapers upwards to form a common top surface with an additional cylindrical projection. Such configuration is due to the fact that the curved projection the top surface of which is common with the top surface of the additional cylindrical projection protects the V-shaped groove from damages which can occur while mating the V-shaped groove with the barrel of the powder-actuated tool using as a rest any rigid surface, upon contact with which the V-shaped groove can be damaged unless there are protective means. In addition, the inventive configuration and structural tandem of the curved projection and the additional cylindrical projection provide the additional rigidity and strength, thus, improving the operative reliability and quality, as well as the lifetime of the nozzle.

The particularly important feature of the present invention is in that the inventive spray nozzle comprises a temporary securing means for temporary securing the spray nozzle to the aerosol container or to the powder-actuated tool in the out-of-service state, thus, allowing a user quickly and easily mate the nozzle prior to its usage or its complete replacement during the usage, for instance, in a case of nozzle possible damage or complete failure. In addition to the above, it is preferable if the means for securing to an aerosol container is made so that in a plan view the spray nozzle has a form of a clip or close to that, which gives the impression of a not-expensive, available, familiar and easy to use a product.

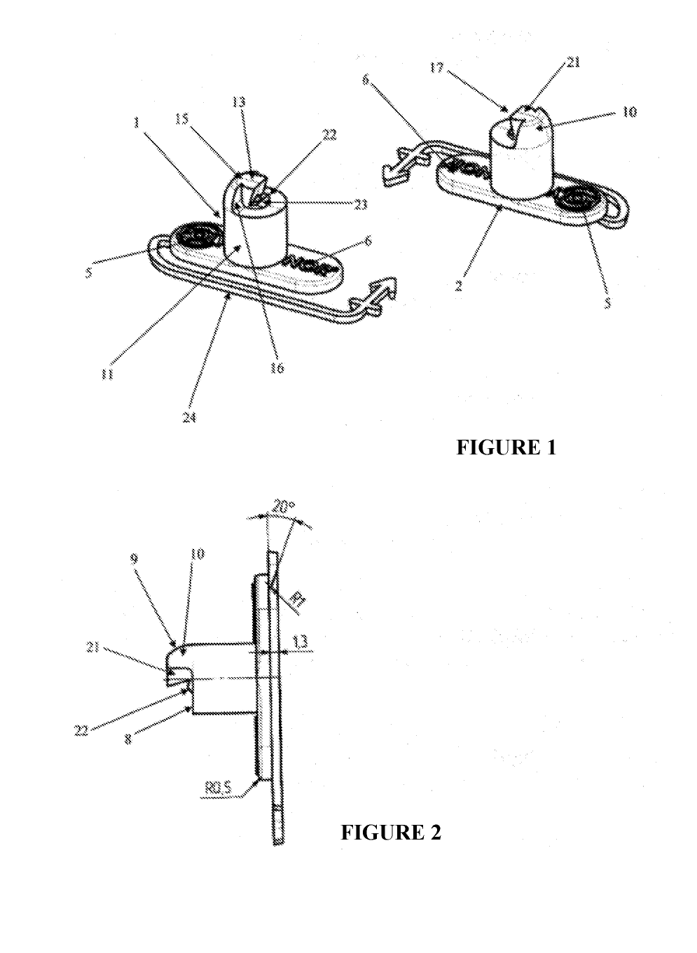

FIG. 1 are general views of the present invention.

FIG. 2 is a view of a first lateral side of the present invention.

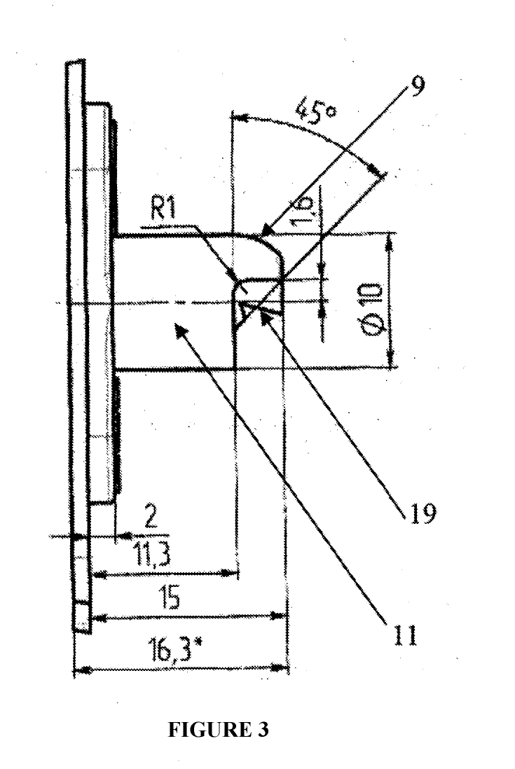

FIG. 3 is a view of a second lateral side of the present invention.

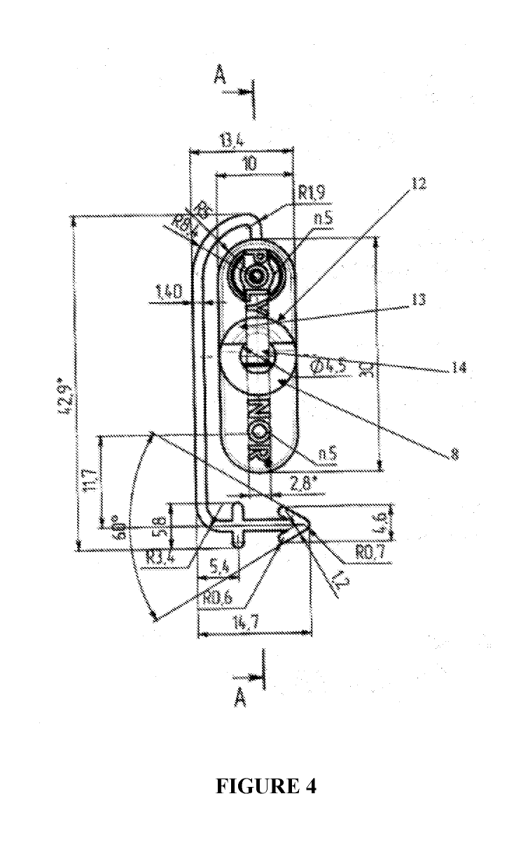

FIG. 4 is a top view of the present invention.

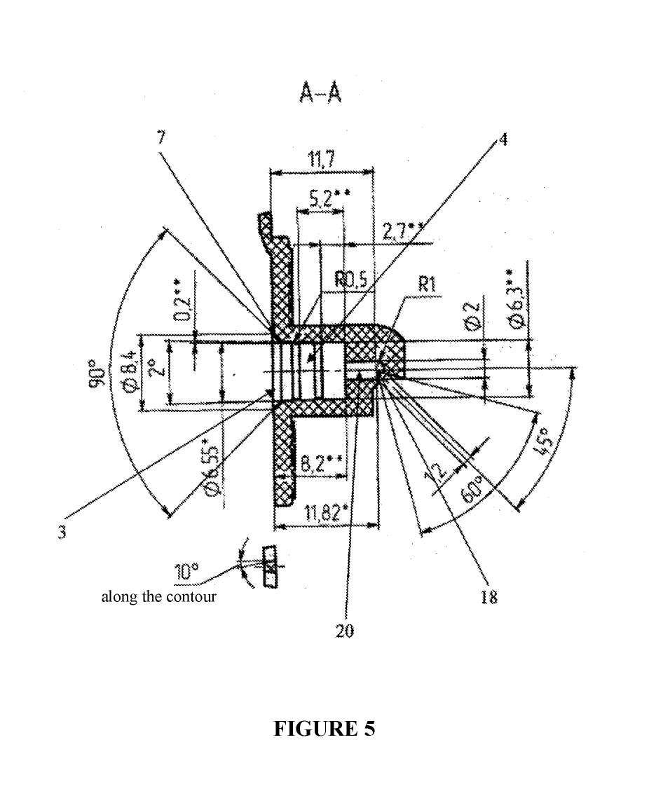

FIG. 5 is a sectional A-A view of FIG. 4.

### EMBODIMENTS OF THE INVENTION

The present invention is described with reference to a specific embodiment which is, however, not the only possible embodiment, and rather illustrates how the combination of features of the technical effect can provide the object of the present invention.

FIGS. 1-5 show the following elements:
A cylinder-like housing 1
A base 2
A mounting bore 3
A cavity of cylinder-like housing 4
A first base lobe 5
A second base lobe 6
A first end of cylinder-like housing 7
A second end of cylinder-like housing 8
A curved projection 9
An outer surface of curved projection 10
An outer surface of cylinder-like housing 11
An arc of curved projection 12
A common top surface of curved projection and additional cylindrical projection 13
An additional cylindrical projection 14
An embedded lateral side of additional cylindrical projection 15
An inner surface of curved projection 16
A free side of additional cylindrical projection 17
An axial section of additional cylindrical projection 18
An inclined acute-angled V-shaped groove 19
An axial opening of second end of cylinder-like housing 20
A bigger part of additional cylindrical projection 21
A smaller part of additional cylindrical projection 22
A top surface of smaller part of additional cylindrical projection 23
A securing means in out-of-service state 24

A spray nozzle of a powder-actuated tool for controlled aerosol spraying of a polyurethane composition at an inclined acute angle comprises a cylinder-like housing 1 which is provided, at a first end 7, with a base 2 having a mounting bore 3.

The mounting bore 3 extends inside the cylinder-like housing 1 forming therein a cavity 4 so as to receive a barrel of the powder-actuated tool to be secured to a container (an aerosol bottle) containing an aerosol composition.

The base 2 is produced in the form of lobes 5 and 6 that protrude beyond the dimensions of the cylinder-like housing 1 and lie opposite one another in a single plane the dimensions of which are sufficient to provide a rest for user's fingers while inserting the barrel of the powder-actuated tool inside the cavity 4 of the cylinder-like housing 1 of the nozzle.

A peripheral section of a second end 8 of the cylinder-like housing 1 which is located on the same side as the first lobe 5 of the base 2 has a projection 9 with a curved cross-section an outer curved surface 10 of which is flushed with an outer surface 11 of the cylinder-like housing 1. In this way, the curved projection 9 has an outer surface which is common with the outer surface 11 of the cylinder-like housing 1.

The length of an arc 12 of the curved projection exceeds the width of the first lobe 5 of the base 2.

The outer surface 10 of the curved projection 9 is rounded and tapers upwards to form a common top surface 13 with an additional cylindrical projection 14 which is concentric to the cylinder-like (cylindrical) housing 1.

A diameter of the additional cylindrical projection 14 is less than a diameter of the cylinder-like (cylindrical) housing 1. The additional cylindrical projection 14 has a lateral wall that is partially embedded into an inner surface 16 of the curved projection 9.

On a free side 17 of the additional cylindrical projection 14 from an edge of the common top surface 13 to an underlying axial section 18 across the entire width, an inclined acute-angled V-shaped groove 19 is made. In this way, on an opposite to the embedded wall of the cylindrical projection 14 side 17 from the edge of the common top surface 13 to the underlying axial section 18 of the additional projection 14 across its entire width (with open lateral sections) the inclined acute-angled V-shaped groove 19 is made.

The inclined acute-angled V-shaped groove 19 is communicating with an axial opening 20 of the second end 8 of the cylinder-like housing 1.

The inclined acute-angled V-shaped groove 19 divides the additional cylindrical projection 14 into two parts—a smaller one and a bigger one. A free part of these two parts is a smaller part 22, and a part which is partially embedded into the inner surface 16 of the curved projection 9 is a bigger part 21.

The top surface 23 of the smaller part 22 of the additional cylindrical projection 14 adjoins (abuts) the second end 8 of the cylinder-like housing 1 and extends under an acute or obtuse angle thereto.

The lobes 5 and 6 of the base 2 which lie opposite one another in a single plane are provided with an antislip surface.

The spray nozzle is provided with a securing means 24 in an out-of-service state.

The securing means 24 has the form of a rod at an end of an extremity of which an arrow-like tip is located opposite to which and perpendicular to the rod is a rest in the form of a crossbar.

The inventive spray nozzle of the powder-actuated tool operates as follows.

The aerosol polyurethane composition is a single-component gas-based polyurethane composition contained in one-liter aerosol bottles.

The inventive spray nozzle is mounted on the barrel of the powder-actuated tool and the aerosol bottle containing the single-component polyurethane composition is screwed on the powder-actuated tool.

The inclined (angular) spraying of a selected surface is achieved in the result of the user-controlled discharge of the polymer composition from the aerosol bottle and an inclined (angular) orientation thereof by means of the unique configuration of the inventive spray nozzle of the powder-actuated tool for the controlled aerosol spraying of the single-component polyurethane medium at an inclined acute angle.

When the inventive nozzle is operated, namely, during preliminary handling and direct operation of the nozzle, the following can occur.

As was mentioned in the “Disclosure of the invention” section, the spray nozzle is made as the cylinder-like (cylindrical) housing 1 which is provided, at the first end 7, with the base 2 having the mounting bore 3. Wherein, the base 2 is produced in the form of lobes 5 and 6 provided with the antislip surface which protrude beyond the dimensions of the cylinder-like housing 1 and lie opposite one another in a single plane the dimensions of which are sufficient to provide a rest for user's fingers while inserting the barrel of the powder-actuated tool inside the cavity 4 of the cylinder-like housing 1 of the nozzle. This configuration provides a reliable rest for user's fingers allowing the fingers to fit completely and with comfort to the lobe 5 and 6 surfaces, thus, providing a comfortable rest contributing to a fast and easy mating of the spray nozzle and the barrel of the powder-actuated tool prior to the works with or during the use of the nozzle by replacing one spray head with another without interrupting the operation process for a long time, and the antislip surface provides an additional stability for user's fingers, for instance, when the user can suffer some sweating during the laborious application of the aerosol polyurethane composition onto any surface.

The base 2 of the spray nozzle comprises a mounting bore 3 that extends inside the cylinder-like housing 1 forming therein a cavity 4 for receiving the barrel of the powder-actuated tool. The dimensions of such cavity 4 are selected so that to provide fast and reliable mating therewith and demating therefrom the barrel of the powder-actuated tool that further will be mounted on a container, in particular, on the aerosol bottle containing the single-component polyurethane composition.

The second end 2 of the cylinder-like (cylindrical) housing 1 is provided with an additional cylindrical projection 14 which is concentric to the cylinder-like housing 1 having a diameter less than the diameter of the cylinder-like housing 1. The additional cylindrical projection 14 has a lateral wall that is partially embedded into an inner surface 16 of the curved projection 9. On a free side 17 of this projection 14 from the edge of a top surface 13 shared with the curved projection 9 to an underlying axial section 18 an inclined, acute-angled V-shaped groove 19 is made across the width which is in communication with an axial opening 20 of the second end 8 of the cylinder-like housing 1. The important advantage of the present invention is in that the V-shaped groove 19 divides the additional cylindrical projection 14 into two parts—a bigger part 21 a lateral wall of which is embedded into the inner surface 16 of the curved projection 12 and a smaller part 22 which is free and is opposite to the bigger part 21. The top surface of the smaller part 22 adjoins (abuts) the second end 8 of the cylinder-like housing 1 and is located at an oblique angle to the end 8 of the cylinder-like housing 1. During the operation of the inventive nozzle, the inclined acute-angled V-shaped groove 19 extending across the width and serving as a composition outlet which divides the additional cylindrical projection 14 into two parts 21 and 22, one of which is the smaller part 22 and its top surface 23 adjoins (abuts) the second end 8 of the cylinder-like housing 1 and is under acute or obtuse angle thereto provides the best inclined (angular) orientation of a polymer jet for uniform and fast inclined (angular) application of the spray composition onto a surface, in addition, the spray composition is stable for “ripening”, i.e., there is an improvement of the high-pressure gas surplus separation during the polymer release which is required during the extrusion. This takes place without discharging high-boiling hydrocarbon blowing agents that aid further polymerization and blowing of a product applied onto the surface. Therefore, the surface being treated is coated with a polyurethane medium in a faster, more uniform and qualitative inclined (angular) way.

In the inventive nozzle, the peripheral section of the second end 8 of the cylinder-like housing 1 is located on the same side as the lobe 5 and has a projection 9 with a curved cross-section the outer curved surface 10 of which is flushed with the outer surface 11 of the cylinder-like housing 1, and length of its arc 12 exceeds the width of the lobe 5 or 6 of the base 2, wherein the outer surface 10 of the curved projection 9 is rounded and tapers upwards to form the common top surface 13 with the additional cylindrical projection 14. Such configuration is due to the fact that during the usage the curved projection 9 the top surface of which is common 13 for the top surface of the additional cylindrical projection 14 protects the inclined V-shaped groove 19 from damages which can occur while mating the V-shaped groove with the barrel of the powder-actuated tool using as a rest any rigid surface, upon contact with which the inclined V-shaped groove 19 can be damaged unless there are protective means. In addition, the inventive configuration and structural tandem of the curved projection 9 and the additional cylindrical projection 14 provides during the usage the additional rigidity and strength, thus, improving the operative reliability and quality, as well as the lifetime of the nozzle.

The important feature of the inventive nozzle is in that it comprises a temporary securing means 24 for temporary securing the spray nozzle to the aerosol container or to the powder-actuated tool in the out-of-service state, thus, allowing a user quickly and easily mate the nozzle prior to its usage or its complete replacement during the usage, for instance, in a case of nozzle possible damage or complete failure.

The present invention is widely used in the industry, in particular, in construction field, and, in particular, can be actively used for heat-insulating walls of residential facilities, outer wall facades of car garages, apartment walls, balconies of apartments in high-rise buildings, large-sized oil storage tanks, as well as walls of foundations of various buildings.

1. A spray nozzle of a powder-actuated tool for controlled aerosol spraying of a polyurethane composition at an inclined acute angle, comprising a cylinder-like housing which is provided, at a first end, with a base having a mounting bore that extends inside said cylindrical housing, thus, forming a cavity therein so as to receive a barrel of the powder-actuated tool to be secured to a container containing an aerosol composition, which base is made in the form of lobes that protrude beyond the housing dimensions and lie opposite one another in a single plane and have the dimensions that are sufficient to provide a rest for user's fingers while inserting the barrel of the powder-actuated tool inside the nozzle cavity, a peripheral section of a second end of the housing located on the same side as one of the lobes and having a projection with a curved cross-section an outer surface of which is flushed with an outer surface of the cylinder-like housing and the length of its arc is more than the width of said lobe, wherein the outer surface of the curved projection is rounded and tapers upwards to form a common top surface with an additional cylindrical projection which is concentric to the cylinder-like housing having a diameter less than the diameter of the latter and has a lateral wall partially embedded into an inner surface of said curved projection, wherein on a free side of the additional projection from a top surface edge to an underlying axial section an inclined, acute-angled V-shaped groove is made across the width in communication with an axial opening of the second end of the housing and dividing the additional projection into parts, wherein a free part of these parts is smaller and its top surface adjoins the second end of the cylinder-like housing and is located at an acute or obtuse angle thereto, and the spray nozzle comprises a securing means for securing the nozzle in an out-of-service state.

2. The spray nozzle according to claim 1, characterized in that the securing means is made so that in a plan view the spray nozzle has the form of a clip or close to that form.

3. The spray nozzle according to claim 2, characterized in that the securing means is made in the form of a rod at an end of an extremity of which an arrow-like tip is located opposite to which and perpendicular to the rod is a rest in the form of a crossbar.
